(19) United States
(12) Patent Application Publication
(10) Pub. No.: US 2025/0248471 A1
(43) Pub. Date: Aug. 7, 2025

(54) HARD HAT ACCESSORY FOR HOLDING WRITING INSTRUMENT

(71) Applicants: Brady CHAFFIN, Becker, MN (US); Cameron CHAFFIN, Zimmerman, MN (US)

(72) Inventors: Brady CHAFFIN, Becker, MN (US); Cameron CHAFFIN, Zimmerman, MN (US)

(21) Appl. No.: 19/043,510

(22) Filed: Feb. 2, 2025

Related U.S. Application Data
(60) Provisional application No. 63/548,812, filed on Feb. 1, 2024.

(51) Int. Cl. A42B 3/04; B43K 23/00

(52) U.S. Cl. CPC A42B 3/0446; B43K 23/001

(57) ABSTRACT

Provided is an accessory holder device, system and method that can be secured to a hard hat and hold both a pencil and a pen while also including a light source to function as either a flashlight or a headlight. A slot is defined in the body of the accessory to hold a common carpenter's pencil and a cylindrical aperture is provided to hold a typical permanent marker or pen. The light source is provided to the body and faces forward away from the user so that the light can function as a headlight. The accessory can be easily removed from the hard hat by the user so that the device can be used as a hand-held flashlight.

### PRIORITY

This application claims the priority benefit of U.S. Provisional Application No. 63/548,812, filed on Feb. 1, 2024, which is hereby incorporated herein by reference in its entirety.

### FIELD

The present invention relates, in general, to gear for construction and other applications where a hard hat is to be worn. More particularly, the invention relates to a writing instrument accessory for use with a hard hat.

### BACKGROUND

It is often necessary for persons in the various trades to wear a hard hat. Often such persons have a need for a writing implement such as a pen or a pencil. Some persons need both. Plus, a flashlight or headlight is a necessity for some. Carrying each of these items can be inconvenient. Therefore, there is a need to provide a convenient accessory that allows a user wearing a hard hat to carry both a pencil and a pen, along with providing a flashlight.

### SUMMARY

The present invention, in certain embodiments, addresses the drawbacks and weaknesses of the prior art by providing an accessory holder device, system and method that can be secured to a hard hat and hold both a pencil and a pen while also including a light source to function as either a flashlight or a headlight. A slot is defined in the body of the accessory to hold a common carpenter's pencil and a cylindrical aperture is provided to hold a typical permanent marker or pen. The light source is provided to the body and faces forward away from the user so that the light can function as a headlight. The accessory can be easily removed from the hard hat by the user so that the device can be used as a hand-held flashlight.

One example of a hard hat accessory provided herein includes a holder body and a clip assembly. The holder body includes a rectangular slot defined inward from an outside surface thereof and a cylindrical aperture defined through the holder body from a front side to a back side thereof. The clip assembly is secured to the holder body and comprises a clip including a tongue portion at a distal end of the clip to engage a hard hat.

The holder body can further include a light aperture defined on a forward end thereof for receiving a light source. The light source can be a self-contained button-sized light emitting diode.

The holder body can include a pair of end caps, the first of which is disposed on a forward end of the holder body and the second of which is disposed on a rear end of the holder body. The cylindrical aperture is also defined through each of the pair of end caps. Each end cap can also comprise a screw aperture defined therein to allow a screw to secure each of the pair of end caps to the holder body.

One or more raised nubs can be disposed in the cylindrical aperture defined in at least one of the pair of end caps and/or disposed in the cylindrical aperture.

The holder body comprises a bulb extending outward from the holder body in a direction opposite the slot. The clip assembly comprises the clip and an adjusting knob. A proximal end of the clip is secured to the bulb and the adjusting knob is secured to the proximal end of the clip. The clip comprises a plurality of fingers defined on a proximal end portion of the clip. The fingers are configured to mate with the bulb. The adjusting knob comprises a center aperture configured so that the adjusting knob is secured over the fingers to secure the clip to the bulb.

In another example provided herein a hard hat and accessory system for holding a pen and pencil therein includes a hard hat and a holder body secured to the hard hat via a clip assembly. The holder body comprises a rectangular slot defined inward from an outside surface thereof and a cylindrical aperture defined through the holder body from a front side to a back side thereof. The clip assembly comprises a clip including a tongue portion at a distal end of the clip to engage the hard hat.

The holder body can further include a light aperture defined on a forward end thereof for receiving a light source.

A pair of end caps can be provided to the holder body. The first of the end caps is disposed on a forward end of the holder body and the second of the end caps is disposed on a rear end of the holder body. The cylindrical aperture is also defined through each of the pair of end caps.

The holder body can include a bulb extending outward from the holder body in a direction opposite the slot. The clip assembly can comprise the clip and an adjusting knob, a proximal end of the clip being secured to the bulb and the adjusting knob being secured to the proximal end of the clip. The clip can comprise a plurality of fingers defined on a proximal end portion of the clip. The fingers are configured to mate with the bulb. The adjusting knob can comprise a center aperture configured so that the adjusting knob is secured over the fingers to secure the clip to the bulb.

Also provided herein is a method of securing a pen and a pencil to a hard hat. The method includes attaching a pen and pencil holder accessory to the hard hat by placing a male end of a clip into a female recess in the hard hat, placing the pencil into a rectangular slot defined inward from an outside surface of a holder body of the pen and pencil holder accessory, and placing a pen through a cylindrical aperture defined through the holder body from a front side to a back side thereof.

The holder body can be secured to the clip by mating a plurality of fingers defined on a proximal end portion of the clip with a bulb defined on the holder body. An adjustment knob can be placed over the fingers to secure the fingers against the bulb.

A light source can be placed into a forward end of a light aperture defined in the holder body.

The above brief summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a front view of a hard hat accessory attached to a hard hat in accordance with embodiments of the present invention.

FIG. 2 is a side view of a hard hat accessory attached to a hard hat in accordance with embodiments of the present invention.

FIG. 3 is a perspective view of a hard hat accessory in accordance with embodiments of the present invention.

FIG. 4 is a front view of a hard hat accessory in accordance with embodiments of the present invention.

FIG. 5 is a rear view of a hard hat accessory in accordance with embodiments of the present invention.

FIG. 6 is a cross-sectional view of a hard hat accessory in accordance with embodiments of the present invention.

FIG. 7 is a top view of a hard hat accessory in accordance with embodiments of the present invention.

FIG. 8 is a first end view of a main body of a hard hat accessory in accordance with embodiments of the present invention.

FIG. 9 is a first side view of the main body of a hard hat accessory attached in accordance with embodiments of the present invention.

FIG. 10 is a second side view, opposite that of FIG. 9, of the main body of a hard hat accessory in accordance with embodiments of the present invention.

FIG. 11 is a second end view, opposite that of FIG. 8, of the main body of a hard hat accessory in accordance with embodiments of the present invention.

FIG. 12 is a side view of an adjuster knob for a hard hat accessory in accordance with embodiments of the present invention.

FIG. 13 is a side view of a clip for a hard hat accessory in accordance with embodiments of the present invention.

FIG. 14 is an end view of an adjuster knob for a hard hat accessory in accordance with embodiments of the present invention.

FIG. 15 is an end view of a clip for a hard hat accessory in accordance with embodiments of the present invention

FIG. 16 is a first side view of an end cap for the main body of a hard hat accessory in accordance with embodiments of the present invention.

FIG. 17 is a second side view of an end cap for the main body of a hard hat accessory in accordance with embodiments of the present invention.

### DETAILED DESCRIPTION

In the following descriptions, the present invention will be explained with reference to various example embodiments; nevertheless, these embodiments are not intended to limit the present invention to any specific example, environment, application, or particular implementation described herein. Therefore, descriptions of these example embodiments are only provided for purpose of illustration rather than to limit the present invention. The invention is to cover all modifications, equivalents, and alternatives falling within the scope of the invention as defined by the appended claims.

The various features or aspects discussed herein can also be combined in additional combinations and embodiments, whether or not explicitly discussed herein, without departing from the scope of the invention.

It should be recognized, however, that the dimensions, proportions, scale and configurations of components are merely example embodiments and can be varied unless specifically limited in a given claim. Thus, the dimensions, proportions, scale and configurations can be varied without departing from the scope of the invention except where explicitly limited by a given claim.

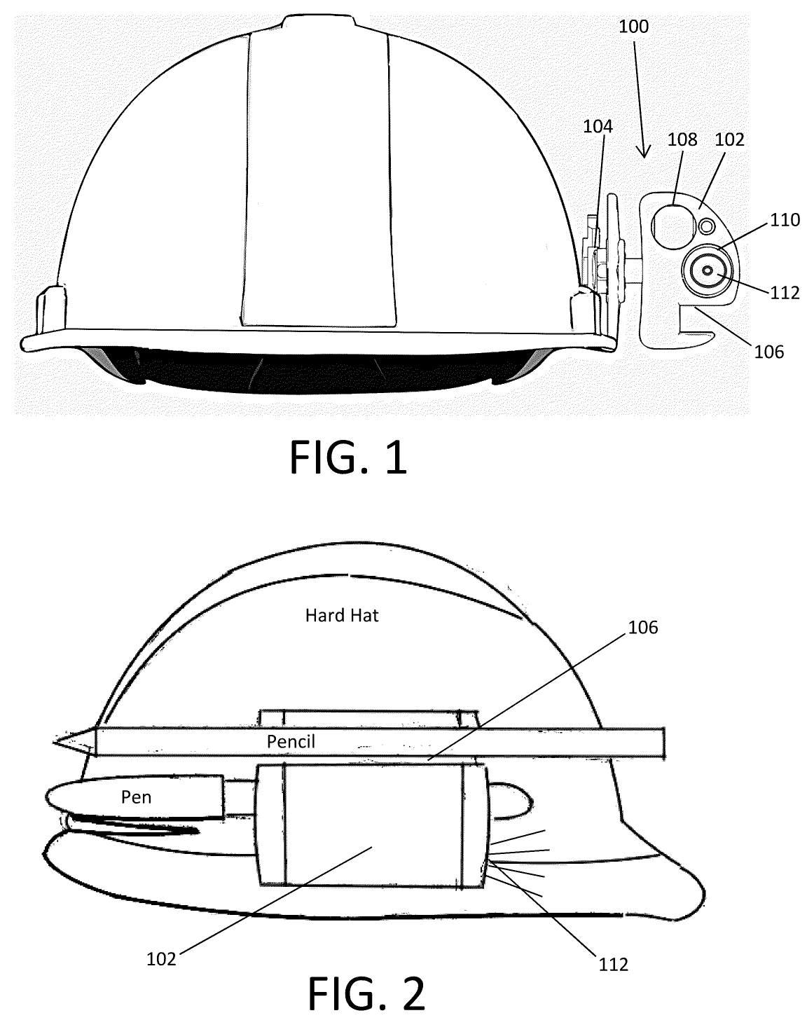

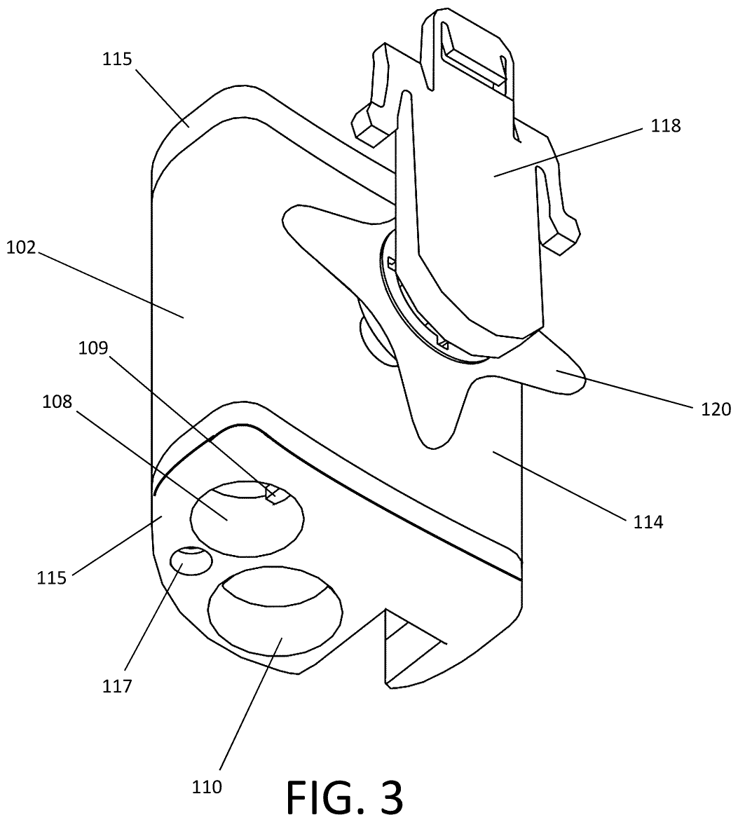

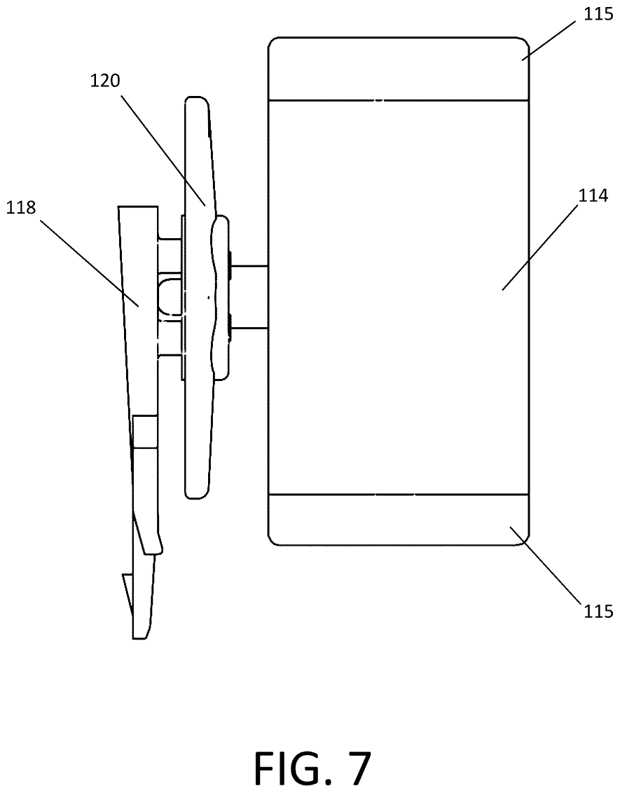

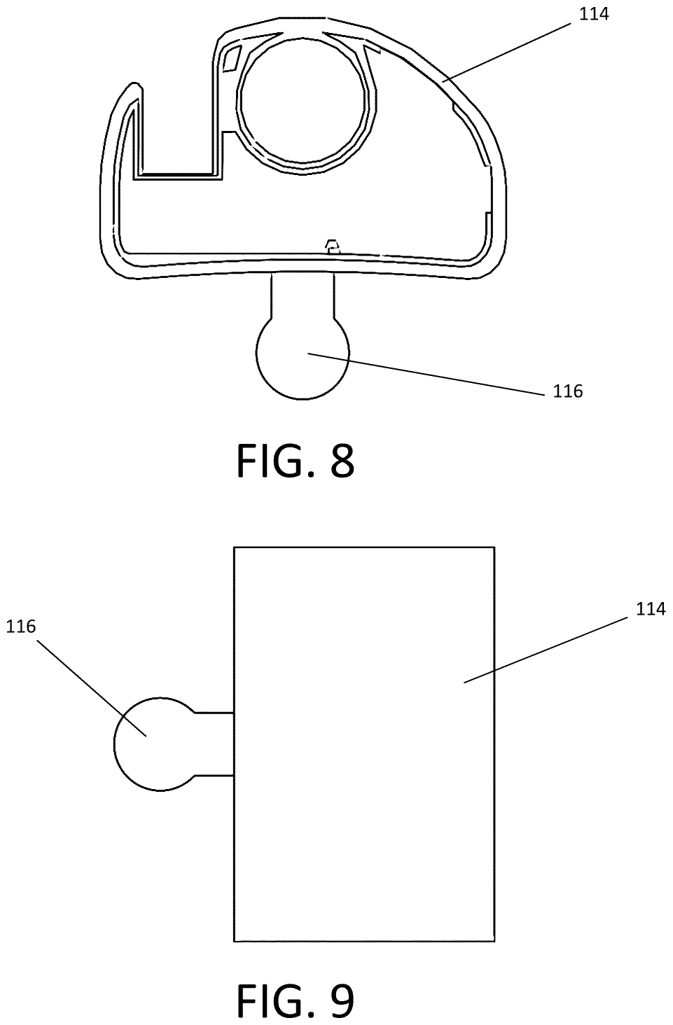

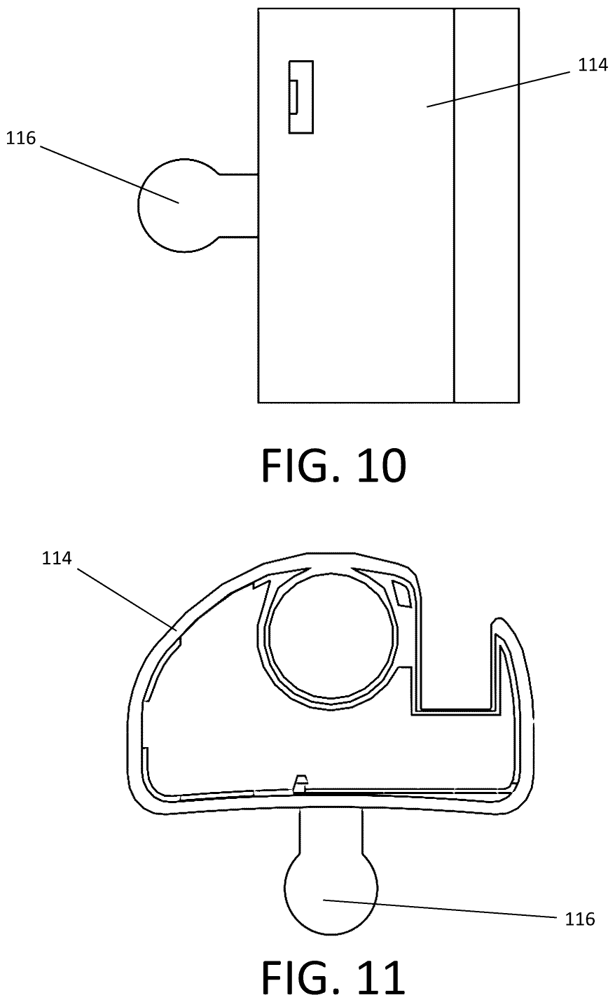

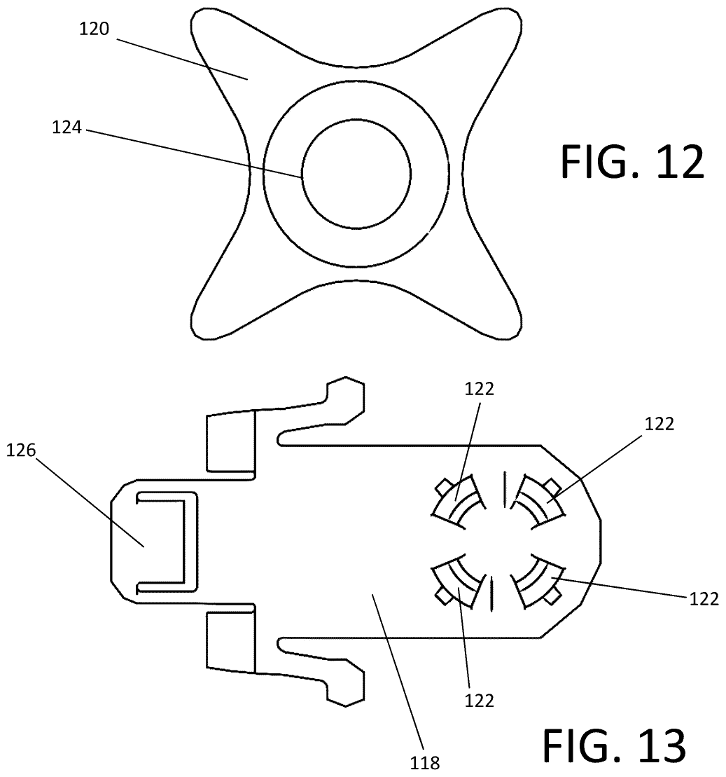

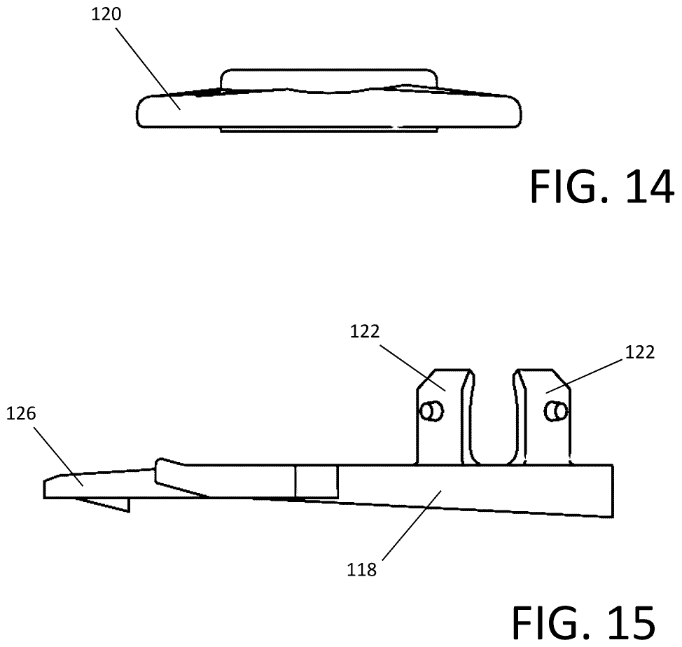

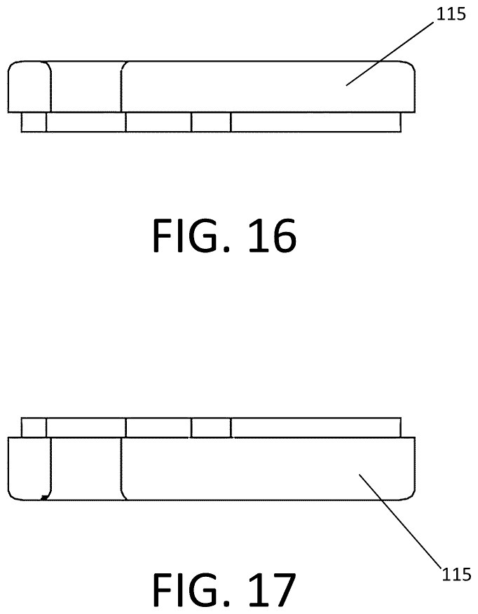

Referring to FIGS. 1-17, the hard hat accessory 100 comprises a holder body 102 and clip assembly 104. The holder body 102 defines a rectangular slot 106 defined inward from an outside surface thereof (i.e., facing away from the hard hat). The rectangular slot 106 is sized to securely hold a common carpenter's pencil such as shown in FIG. 2. A cylindrical aperture 108 is defined through the body 102 from the front to back sides thereof. The cylindrical aperture 108 has a diameter sized to hold a common pen or marker such as shown in FIG. 2. A rib or raised nub 109 is defined in the cylindrical aperture 108 to provide an interference fit for the pen so that the pen is securely retained in the cylindrical aperture 108. More than one rib or nub 109 can be provided.

The holder body 102 further includes a light aperture 110 defined on a forward end thereof for receiving a light source 112, such as a self-contained button-sized light emitting diode. However, the shape, size and depth of the light aperture 110 can be varied to securely receive a variety of light sources. The light 112 can be turned on and off by pressing inward against the light's outer surface. A separate on/off switch can also be provided.

Referring particularly to FIGS. 8-11 and 16-17, the holder body 102 comprises a main body 114 and a pair of end caps 115 secured to the main body 114. The end caps 115 include the apertures and nubs referenced above for the pen and light source plus the slot 106 for the pencil. The main body 114 includes corresponding apertures and the slot extending therethrough. A screw aperture 117 is defined in each of the end caps so that each of the end caps 115 can be secured to the main body 114.

The placement of the cylindrical aperture 108 and the light aperture 110 is relative and the locations can be reversed from what is depicted in the figures.

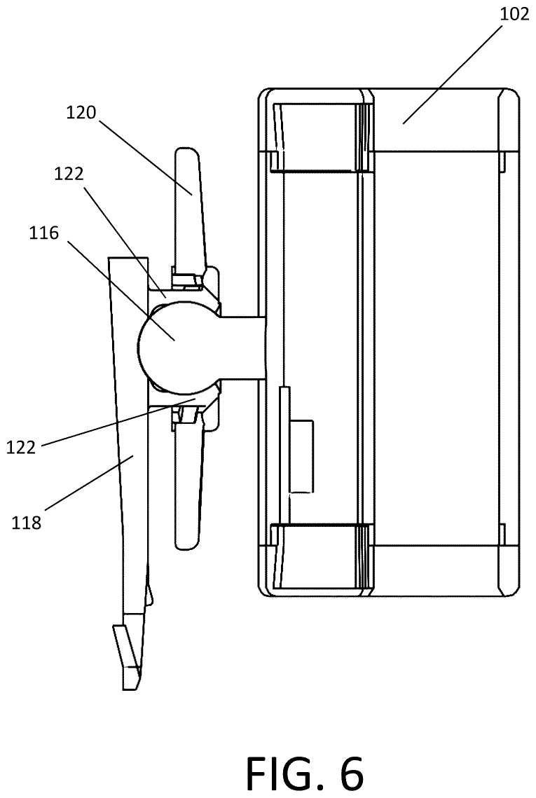

Referring particularly to FIGS. 6 and 12-15, the holder body 102 further comprises a bulb 116 extending inward toward the hard hat from the inward side of the main body 114 (opposite direction of the rectangular slot 106). The clip assembly 104 comprises a clip 118 and adjusting knob 120. Both of the clip 118 and adjusting knob 120 are disposed over the bulb 116. The clip 118 and knob 120 are held in place via a plurality of fingers 122 defined on the clip which are compressed against the bulb 116 by a center aperture 124 of the adjusting knob 120. The fingers 122 have inner surfaces contoured to mate with the curved outer surface of the bulb 116 as can be seen in FIG. 6. The clip 118 defines a tongue portion 126 that engages a female recess defined in the hard hat.

The tolerances of the fingers 122, bulb 116 and center aperture 124 of the knob 120 can be adjusted to create an interference or snug fit so that the accessory body 102 cannot be unintentionally separated from the clip 118. Moreover, the snugness of the fit of these components allows the user to adjust the aim of the accessory body 102 relative to the hard hat and the chosen adjustment will hold in place until the use provides sufficient force to change the adjustment.

In an alternative embodiment, the surfaces of the adjustment knob 120 and clip 118 that face one another can be provided with respective circular sawtooth rings so that the relative elevation angle of the accessory body can be set and maintained relative to the hard hat.

The multiple separate pieces of the accessory 100 allow for the various parts to be produced more easily and less expensively via molding procedures.

The body 102 and clip assembly 116 are preferably formed of a rigid plastic material. The fasteners are preferably a metal material.

Gripping pads can be provided in the slot 106 and/or in the pen/marker aperture 108 to aid in securely retaining the writing instrument.

FIG. 2 shows the accessory 100 with a carpenter's pencil and a permanent marker inserted into their respective slot 106 and aperture 108. The light 112 is indicated by the lines depicting light emanating from the light source.

The pencil and pen/marker slot 106/aperture 108 can be used in either left or right-handed configurations. Thus, the accessory 100 can be used on either side of a hard hat as preferred by the user. Also, a light aperture 110 for the light 112 can be provided to either of the front end or rear end of the body 102 so that the light 112 can be repositioned such that it is always illuminated forward from the user like a headlight. Thus, it should be understood that the front/back end caps 115 are merely relative to one another.

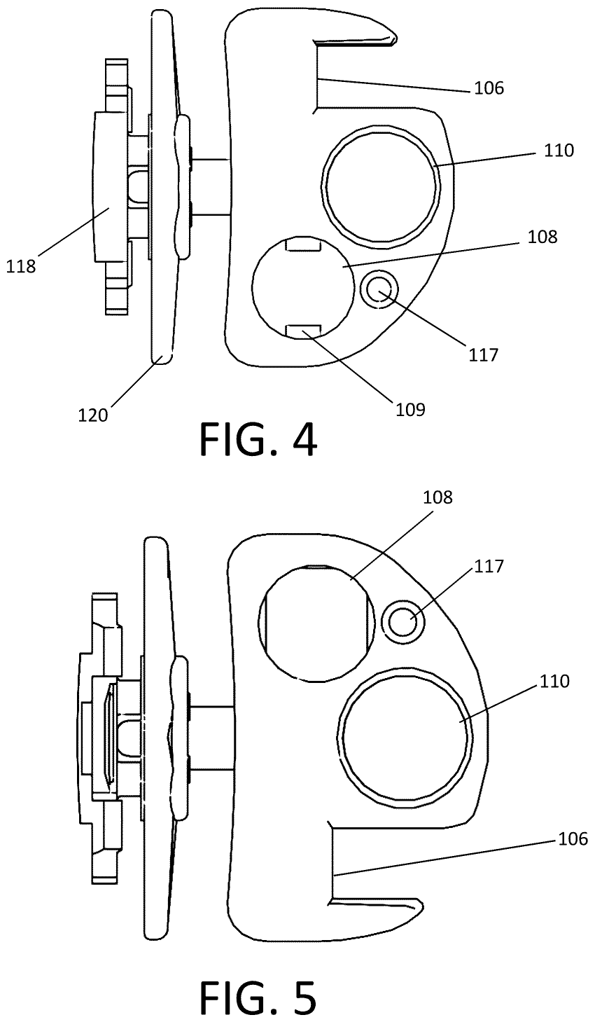

The accessory 100 can also be vertically inverted as desired by the user. For example, the pencil slot 106 can be either towards the top or towards the bottom depending on which orientation the user employs by manipulating the adjustment knob 120. Compare, for example, the orientations of FIGS. 1 and 2 or the orientations shown in FIGS. 4 and 5.

FIGS. 1-2 show the holder accessory 100 secured to a hard hat in one use example. It should be understood that the present accessory holder 100 can be adapted to a variety of hard hats, helmets or other headwear by employing an appropriately-configured clip body 118 for the particular application.

Also, in use, the user can detach the accessory body 102 from the clip body 118 without needing to remove their hard hat from their head. The user grasps the body 102 and moves it upward relative to the hard hat until the knob releases from the clip body 118. Then the user can use the accessory 100 as a handheld flashlight.

The user can also adjust the elevational angle by applying a rotational force to the body 102 relative to the hard hat until the force of the fingers 122 and bulb 116 is overcome and the user achieves the desired aim. That aim will be maintained until changed again by the user.

While the invention has been described in connection with what is presently considered to be the most practical and preferred example embodiments, it will be apparent to those of ordinary skill in the art that the invention is not to be limited to the disclosed example embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A hard hat accessory, comprising:
a holder body, including a rectangular slot defined inward from an outside surface thereof and a cylindrical aperture defined through the holder body from a front side to a back side thereof; and
a clip assembly secured to the holder body, comprising a clip including a tongue portion at a distal end of the clip to engage a hard hat.

2. The hard hat accessory of claim 1, wherein the holder body further includes a light aperture defined on a forward end thereof for receiving a light source.

3. The hard hat accessory of claim 2, wherein the light source is a self-contained button-sized light emitting diode.

4. The hard hat accessory of claim 1, further comprising a pair of end caps, the first of which is disposed on a forward end of the holder body and the second of which is disposed on a rear end of the holder body, wherein the cylindrical aperture is also defined through each of the pair of end caps.

5. The hard hat accessory of claim 4, wherein each of the pair of end caps comprises a screw aperture defined therein to allow a screw to secure each of the pair of end caps to the holder body.

6. The hard hat accessory of claim 4, wherein one or more raised nubs are disposed in the cylindrical aperture defined in at least one of the pair of end caps.

7. The hard hat accessory of claim 1, wherein one or more raised nubs are disposed in the cylindrical aperture.

8. The hard hat accessory of claim 1, wherein the holder body comprises a bulb extending outward from the holder body in a direction opposite the slot.

9. The hard hat accessory of claim 8, wherein the clip assembly comprises the clip and an adjusting knob, a proximal end of the clip being secured to the bulb and the adjusting knob being secured to the proximal end of the clip.

10. The hard hat accessory of claim 9, wherein the clip comprises a plurality of fingers defined on a proximal end portion of the clip, wherein the fingers are configured to mate with the bulb, and wherein the adjusting knob comprises a center aperture configured so that the adjusting knob is secured over the fingers to secure the clip to the bulb.

11. A hard hat and accessory system for holding a pen and pencil therein, the hard hat and accessory system comprising:
a hard hat; and
a holder body secured to the hard hat via a clip assembly,
wherein the holder body comprises a rectangular slot defined inward from an outside surface thereof and a cylindrical aperture defined through the holder body from a front side to a back side thereof; and
wherein the clip assembly comprises a clip including a tongue portion at a distal end of the clip to engage the hard hat.

12. The hard hat and accessory system of claim 11, wherein the holder body further includes a light aperture defined on a forward end thereof for receiving a light source.

13. The hard hat and accessory system of claim 11, further comprising a pair of end caps, the first of which is disposed on a forward end of the holder body and the second of which is disposed on a rear end of the holder body, wherein the cylindrical aperture is also defined through each of the pair of end caps.

14. The hard hat and accessory system of claim 11, wherein the holder body comprises a bulb extending outward from the holder body in a direction opposite the slot.

15. The hard hat and accessory system of claim 14, wherein the clip assembly comprises the clip and an adjusting knob, a proximal end of the clip being secured to the bulb and the adjusting knob being secured to the proximal end of the clip.

16. The hard hat and accessory system of claim 15, wherein the clip comprises a plurality of fingers defined on a proximal end portion of the clip, wherein the fingers are configured to mate with the bulb, and wherein the adjusting knob comprises a center aperture configured so that the adjusting knob is secured over the fingers to secure the clip to the bulb.

17. A method of securing a pen and a pencil to a hard hat, the method comprising:
attaching a pen and pencil holder accessory to the hard hat by placing a male end of a clip into a female recess in the hard hat;
placing the pencil into a rectangular slot defined inward from an outside surface of a holder body of the pen and pencil holder accessory; and
placing a pen through a cylindrical aperture defined through the holder body from a front side to a back side thereof.

18. The method of claim 17, further comprising:
securing the holder body to the clip by mating a plurality of fingers defined on a proximal end portion of the clip with a bulb defined on the holder body.

19. The method of claim 18, further comprising placing an adjustment knob over the fingers to secure the fingers against the bulb.

20. The method of claim 17, further comprising placing a light source into a forward end of a light aperture defined in the holder body.
